(19) United States
(12) Patent Application Publication
(10) Pub. No.: US 2025/0131764 A1
(43) Pub. Date: Apr. 24, 2025

(54) IMAGE PROCESSING APPARATUS, IMAGE PROCESSING METHOD, AND NON-TRANSITORY RECORDING MEDIUM

(71) Applicant: NEC Corporation, Minato-ku, Tokyo (JP)

(72) Inventor: Shigeru Nakamura, Tokyo (JP)

(73) Assignee: NEC Corporation, Minato-ku, Tokyo (JP)

(21) Appl. No.: 18/725,186

(22) PCT Filed: Mar. 2, 2022
(86) PCT No.: PCT/JP2022/008908

§ 371 Date: Dec. 18, 2024

(51) Int. Cl. G06V 40/12; G01B 9/02091; G06V 10/75; G06V 40/13

(52) U.S. Cl. CPC G06V 40/1347; G01B 9/02091; G06V 10/7515; G06V 40/1312

(57) ABSTRACT

An image processing apparatus comprises: an acquisition unit 11 acquires a three-dimensional luminance data of skin, the data being generated by optical coherence tomography performed by irradiating the skin of a finger with an optical beam in a two-dimensionally scanning manner; a first extraction unit 12 extracts from the three-dimensional luminance data of the skin, a pattern image of a pattern of the skin; a second extraction unit 213 extracts from the three-dimensional luminance data of the skin, a normal direction of a surface of the skin; and a generation unit 214 moves a position of a pixel included in the pattern image based on the normal direction to generate a post-move pattern image.

### TECHNICAL FIELD

This disclosure relates to an image processing apparatus, an image processing method, and a recording medium.

### BACKGROUND ART

In the Patent Literature 1, there is disclosed a fingerprint imaging apparatus for obtaining a fingerprint image of a surface skin in a non-contact manner while passing through a predetermined location without contacting a fingertip with a glass plate or the like, the fingerprint image being used for a biometric authentication. In the Patent Literatures 2 to 4, there is disclosed another fingerprint imaging apparatuses where with the optical coherence tomography (OCT) technique, three-dimensional tomographic imaging of the fingertip is performed to obtain a fingerprint image of the dermis skin, the fingerprint image being used for biometric authentication.

### CITATION LIST

### Patent Literature

Patent Literature 1: WO-A1-2009/112717
Patent Literature 2: WO-A1-2016/204176
Patent Literature 3: WO-A1-2020/170439
Patent Literature 4: WO-A1-2021/019788

### SUMMARY

### Technical Problem

This disclosure aims to provide an image processing apparatus, an image processing method, and a recording medium, each being intended to improve the techniques disclosed in the Citation List.

### Solution to Problem

On aspect of an image processing apparatus comprises: an acquisition unit that is configured to acquire a three-dimensional luminance data of skin, the data being generated by optical coherence tomography performed by irradiating the skin of a finger with an optical beam in a two-dimensionally scanning manner; a first extraction unit that is configured to extract from the three-dimensional luminance data of the skin, a pattern image of a pattern of the skin; a second extraction unit that is configured to extract from the three-dimensional luminance data of the skin, a normal direction of a surface of the skin; and a generation unit that is configured to move a position of a pixel included in the pattern image based on the normal direction to generate a post-move pattern image.

One aspect of an image processing method comprises: acquiring a three-dimensional luminance data of skin, the data being generated by optical coherence tomography performed by irradiating the skin of a finger with an optical beam in a two-dimensionally scanning manner; extracting from the three-dimensional luminance data of the skin, a pattern image of a pattern of the skin; extracting from the three-dimensional luminance data of the skin, a normal direction of a surface of the skin; and moving a position of a pixel included in the pattern image based on the normal direction to generate a post-move pattern image.

One aspect of a recording medium stores a computer program that makes a computer execute an image processing method, the image processing method comprising: acquiring a three-dimensional luminance data of skin, the data being generated by optical coherence tomography performed by irradiating the skin of a finger with an optical beam in a two-dimensionally scanning manner; extracting from the three-dimensional luminance data of the skin, a pattern image of a pattern of the skin; extracting from the three-dimensional luminance data of the skin, a normal direction of a surface of the skin; and moving a position of a pixel included in the pattern image based on the normal direction to generate a post-move pattern image.

### BRIEF DESCRIPTION OF DRAWINGS

FIG. 1 is a block diagram showing a configuration of an image processing apparatus according to a first example embodiment.

FIG. 2 is a block diagram showing a configuration of an image processing apparatus according to a second example embodiment.

FIG. 3 is a block diagram showing a configuration of an optical coherence tomography imaging apparatus.

FIG. 4 is a diagram showing by an example, a three-dimensional luminance data acquired in the optical coherence tomography.

FIG. 5 is a flowchart showing a flow of an image processing operation according to the second example embodiment.

FIG. 6 is a conceptual diagram of generation of a pattern image according to the second example embodiment.

FIG. 7 is a conceptual diagram of generation of a post-move pattern image according to the second example embodiment.

FIG. 8 is a diagram showing a working example of the image processing operation according to the second example embodiment.

FIG. 9 is a conceptual diagram of an image processing operation according to a fourth example embodiment.

FIG. 10 is a block diagram showing a configuration of an image processing apparatus according to a fifth example embodiment.

### DESCRIPTION OF EXAMPLE EMBODIMENTS

Referring to the drawings, there will be described below example embodiments of the image processing apparatus, the image processing method, and the recording medium.

### 1: First Example Embodiment

A first example embodiment with respect to the image processing apparatus, image processing method, and recording medium will be described. In the following, using the image processing apparatus 1 to which the first example embodiment of the image processing apparatus, image processing method, and recording medium is applied, the first example embodiment with respect to the image processing apparatus, image processing method, and recording medium will be described.

### [1-1: Configuration of Image Processing Apparatus 1]

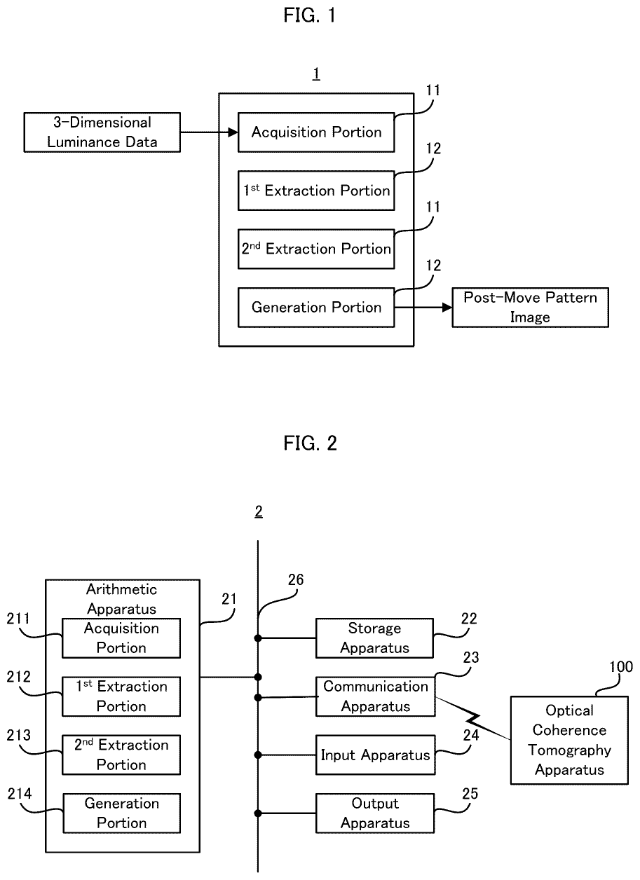

Referring to FIG. 1, a configuration of the image processing apparatus 1 according to the first example embodiment will be described. FIG. 1 is a block diagram showing the configuration of the image processing apparatus 1 according to the first example embodiment.

As shown in FIG. 1, the image processing apparatus 1 includes an acquisition portion 11, a first extraction portion 12, a second extraction portion 13, and a generation portion 14. The acquisition portion 11 acquires three-dimensional luminance data of skin generated by performing optical coherence tomography by irradiating finger skin with an optical beam in a two-dimensionally scanning manner. The first extraction portion 12 extracts a pattern image of the skin pattern from the three-dimensional luminance data of the skin. The second extraction portion 13 extracts a normal direction of the surface of the skin from the three-dimensional luminance data of the skin. The generation portion 14 moves positions of pixels included in the pattern image based on the normal direction of the surface of the skin, to generate a post-movement pattern image.

### [1-2: Technical Effectiveness of Image Processing Apparatus 1]

Since the image processing apparatus extracts the pattern image and the normal direction from the same three-dimensional luminance data, it is possible to generate the pattern image appropriately on the basis of the normal direction, compared with a comparative example in which image acquired from an imaging apparatus is converted using shape information acquired from an apparatus different from the imaging apparatus.

### 2: Second Example Embodiment

A second example embodiment with respect to the image processing apparatus, image processing method, and recording medium will be described. In the following, using the image processing apparatus 2 to which the second example embodiment of the image processing apparatus, image processing method, and recording medium is applied, the second example embodiment with respect to the image processing apparatus, image processing method, and recording medium will be described.

The image processing apparatus 2 may be, for example, a computer such as a data processing server, a desktop PC (Personal Computer), a notebook PC, a tablet PC, or the like.

### [2-1: Configuration of Image Processing Apparatus 2]

Referring to FIG. 2, a configuration of the image processing apparatus 2 in the second example embodiment will be described. FIG. 2 is a block diagram showing the configuration of the image processing apparatus 2 according to the second example embodiment.

As shown in FIG. 2, the image processing apparatus 2 includes an arithmetic apparatus 21 and a storage apparatus 22. In addition, the image processing apparatus 2 may include a communications apparatus 23, an input apparatus 24, and an output apparatus 25. However, the image processing apparatus 2 may not include at least one of the communication apparatus 23, the input apparatus 24 and the output apparatus 25. The arithmetic apparatus 21, the storage apparatus 22, the communication apparatus 23, the input apparatus 24, and the output apparatus 25 may be connected through the data bus 26.

The arithmetic apparatus 21 includes at least one of, for example, CPU (Central Processing Unit), GPU (Graphics Processing Unit), and FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-transitory recording medium, using a recording medium reading apparatus (not shown) provided by the image processing apparatus 2 (e.g., the input apparatus 24, described later). The arithmetic apparatus 21 may acquire (i.e., download or read) via the communication apparatus 23 (or the other communication apparatus), a computer program from a not-shown apparatus disposed outside the image processing apparatus 2. The arithmetic apparatus 21 executes the computer program loaded. Consequently, in the arithmetic apparatus 21, logical function blocks for executing operations to be performed by the image processing apparatus 2 are realized. In other words, the arithmetic apparatus 21 can function as a controller for realizing the logical function blocks for executing operations (in other words, processing) to be performed by the image processing apparatus 2.

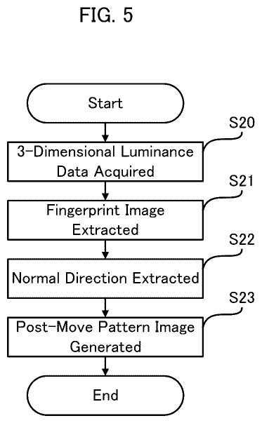

In FIG. 2, there is shown an example of the logical function blocks realized in the arithmetic apparatus 21, for performing the image processing operations. As shown in FIG. 2, there are realized in the arithmetic apparatus 21, an acquisition portion 211 which is a specific example of the “acquisition unit”, a first extraction portion 212 which is a specific example of the “first extraction unit”, a second extraction portion 213 which is a specific example of the “second extraction unit”, and a generation portion 214 which is a specific example of the “generation unit”. The operation of each of the acquisition portion 211, first extraction portion 212, second extraction portion 213, and generation portion 214 will be described later with reference to FIGS. 5 to 7.

The storage apparatus 22 is capable of storing desired data. For example, the storage apparatus 22 may temporarily store computer programs executed by the arithmetic apparatus 21. The storage apparatus 22 may temporarily store data that is temporarily used by the arithmetic apparatus 21 when the arithmetic apparatus 21 is running a computer program. The storage apparatus 22 may store data that the image processing apparatus 2 stores in the long term. The storage apparatus 22 may include at least one of a RAM (Random Access Memory), a ROM (Read Only Memory), a hard-disk apparatus, a magneto-optical disk apparatus, an SSD (Solid State Drive) and a disk-array apparatus. That is, the storage apparatus 22 may include a non-transitory recording medium.

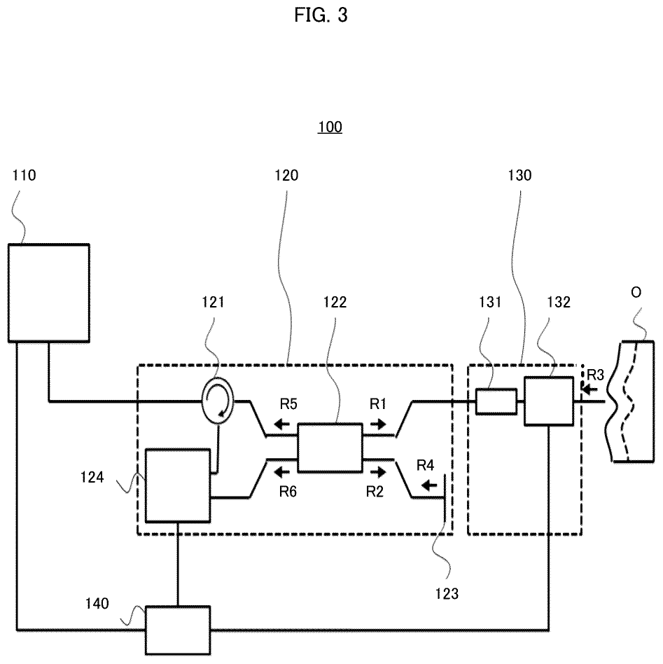

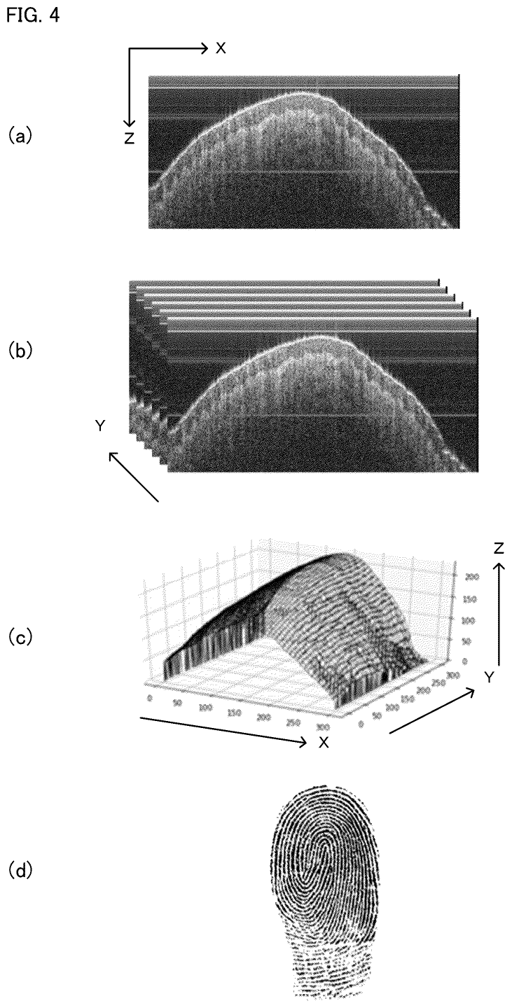

The communication apparatus 23 can communicate with an apparatus external to the image processing apparatus 2 through a not-shown communication network. The communication apparatus 23 may be a communication interface based on standards such as Ethernet (Registered Trademark), Wi-Fi (Registered Trademark), and Bluetooth (Registered Trademark). The communication apparatus 23 may acquire the three-dimensional data indicating the three-dimensional shape of the skin from the optical coherence tomography apparatus 100 through the communication network. The optical coherence tomography apparatus 100 will be described later with reference to FIGS. 3 and 4.

The input apparatus 24 is an apparatus that accepts information inputted to the image processing apparatus 2 from the outside of the image processing apparatus 2. For example, the input apparatus 24 may include an operating apparatus operable by an operator of the image processing apparatus 2 (e.g., at least one of a keyboard, a mouse trackball, a touch panel, a pointing device such as a pen tablet, a button, and the like). For example, the input apparatus 24 may include a read apparatus that can read information stored in an external recording medium to the image processing apparatus 2.

The output apparatus 25 is an apparatus that outputs information to the outside of the image processing apparatus 2. For example, the output apparatus 25 may output information as an image. In other words, the output apparatus 25 may include a display apparatus (so-called a display) that is capable of displaying an image indicating information to be outputted. As an example of the display apparatus, there are a liquid crystal display, an OLED (Organic Light Emitting Diode) display, and the like. For example, the output apparatus 25 may output information as sound. That is, the output apparatus 25 may include an audio apparatus (so-called a speaker) capable of outputting sound. For example, the output apparatus 25 may output information to the paper surface. In other words, the output apparatus 25 may include a print apparatus (so-called printer) that can print desired information on the paper surface. The input apparatus 24 and the output apparatus 25 may be integrally formed as a touch panel.

The hardware configuration shown in FIG. 2 is one example. An apparatus other than the apparatuses shown in FIG. 2 may be added, and a part of the apparatuses may not be provided. In addition, a part of the apparatuses may be substituted for other apparatuses each having a similar function. In addition, apart of the functions of the present example embodiment may be provided via a network by the other apparatus. The functions of the present example embodiment may be distributed among a plurality of apparatuses to be realized. Alternatively, for example, the image processing apparatus 2 and the optical coherence tomography apparatus 100 may be an integral apparatus. Thus, the hardware configuration shown in FIG. 2 can be changed as appropriate.

Note that, although a case in which the three-dimensional luminance data of the skin generated by OCT imaging is used will be described below, in the present example embodiment, the first extraction operation, the second extraction operation, and the generation operation may be performed using three-dimensional information indicating a three-dimensional shape of the skin generated by the other method.

### [2-2: Optical Coherence Tomography Apparatus 100]

The optical coherence tomography apparatus 100 performs the optical coherence tomography by irradiating the finger skin with an optical beam in a two-dimensionally scanning manner, and generates the three-dimensional luminance data of the skin.

The OCT imaging is a technique to specify the position of a part (light scattering point) where the object light is scattered in a measurement target with respect to the optical axis direction, that is, the depth direction, by utilizing interference between the object light and the reference light, and to obtain structural data where spatial decomposition is implemented in the depth direction in the measurement target part. There are two OCT techniques: Time Domain (TD-OCT) system and Fourier Domain (FD-OCT) system. In FD-OCT system, the interfering light spectrum of the wide wavelength band is measured, when the object light and the reference light interfere with each other, and the structural data in the depth direction is obtained by the Fourier transform of it. As a system for obtaining the interfering light spectrum, there are Spectral Domain (SD-OCT) system using a spectroscope and Swept Source (SS-OCT) system using a light source which sweeps the wave length.

Furthermore, by scanning an irradiation position of the object beam R3 with respect to an in-plane direction perpendicular to the depth direction of the measurement target, it is possible to obtain a fault structure data of the measurement target which is spatially resolved with respect to the in-plane direction and also spatially resolved in the depth direction, that is, a three-dimensional fault structure data of the measurement target.

The optical coherence tomography apparatus 100 may be configured so that an image of a hand, with the palm up, put on a stage is taken from above, or may be configured so that a palm facing downward is held over an image-taking device. Further, the configuration that an image a hand with the palm up may be taken from above, without putting the hand on the stage, may be applied. In this case, the stage may not be included in the optical coherence tomography apparatus 100.

FIG. 3 is a diagram showing the configuration of the optical coherence tomography apparatus 100. The optical coherence tomography apparatus 100 images a portion such as a finger of a person based on a three-dimensional measuring technique such as OCT imaging, and generates three-dimensional luminance data including the inside of the skin. The configuration diagram shown in FIG. 3 is only an exemplary measuring instrument using OCT imaging, and it may be a measuring instrument having a configuration other than that shown in FIG. 3.

FIG. 3 shows by an example, the optical coherence tomography apparatus 100 with the SS-OCT system. As shown in FIG. 3, the optical coherence tomography apparatus 100 includes a wavelength-swept laser light source 110, an optical-interference light receiving portion 120, an optical beam scanning portion 130, and a signal processing control portion 140. The optical-interference light receiving portion 120 includes a circulator 121, a branching and merging portion 122, a reference light mirror 123, and a balance type photoreceiver 124. The optical beam scanning portion 130 includes a fiber collimator 131, and an irradiation optical system 132. The irradiation optical system 132 has a scanning mirror and a lens.

The wavelength-swept laser light source 110 is a laser that emits light while sweeping the wavelength. The wavelength-swept laser light source 110 generates and outputs the wavelength-swept light pulses. The wavelength-swept laser light source 110 sweeps from 1250 nm to 1350 nm in wavelength during 5 μs duration to generate the light pulses. The wavelength-swept laser light source 110 generates the light pulses of 100 kHz repetition rate. The optical coherence tomography apparatus 100 generates the light pulses that repeat every 10 μs.

The light emitted from the wavelength-swept laser light source 110 is applied to and scattered by the measuring target O through the optical-interference light receiving portion 120 and the optical beam scanning portion 130. The optical-interference light receiving portion 120 photoelectrically converts a part of the scattered light, and outputs an electric signal.

The signal processing control portion 140 digitizes the electric signal outputted by the optical-interference-light receiving portion 120, and sends the digitized data to the image processing apparatus 2.

### [Operation of the Optical-Interference Light Receiving Portion 120]

The branching and merging portion 122 branches the light into the object light R1 and the reference light R2, the light being emitted from the wavelength-swept laser light source 110 and passing through the circulator 121.

The object light R1, through the fiber collimator 131 and the irradiation optical system 132, is emitted to the measuring target O. The object light R1 scattered in the measuring target O is referred to as an object light R3. The object light R3 returns to the branching and merging portion 122.

The reference light R2 is applied to and reflected on the reference light mirror 123. The reference light R2 reflected on the reference light mirror 123 is referred to as a reference light R4. The reference light R4 returns to the branching and merging portion 122. The object light R3 scattered from the measuring target O and the reference light R4 reflected on the reference light mirror 123 interferes with each other in the branching and merging portion 122, and an interference light R5, and an interference light R6 are generated. That is, the intensity ratio of the interference light R5 and the interference light R6 is determined by the phase difference between the object light R3 and the reference light R4.

The balance type photoreceiver 124 is a type of two-input, and the interference light R6 and the interference light R5 passing through the circulator 121 are input.

The balance type photoreceiver 124 outputs a voltage corresponding to the intensity difference between the interference light R5 and the interference light R6. The voltage outputted by the balance type photoreceiver 124 is inputted to the signal processing control portion 140.

### [A Scan]

The signal processing control portion 140 generates the interfering light spectrum data, based on: information about the wavelength variation of the light emitted by the wavelength-swept laser light source 110; and information about the change in the intensity ratio between the interference light R5 and the interference light R6. The signal processing control portion 140 fourier-transforms the interfering light spectrum data generated, and acquires data indicating the intensity of the backscattered light (the object light) at different depth positions in the depth direction (also referred to as the “Z direction”).

Hereinafter, the operation of obtaining the data indicating the intensity of the backscattered light (the object light) in the depth direction (the Z direction) of the irradiation position of the object light R3 in the measuring target O, is referred to as “A-scan”. To the signal processing control portion 140, an electric signal having a repetition frequency 100 kHz is supplied, as an A-scan trigger signal, from the wavelength-swept laser light source 110. Thereby, the signal processing control portion 140 generates an A-scan waveform every 10s repetition period of the light pulse. The signal processing control portion 140 generates as the A-scan waveform, a waveform indicating the object-light backscatter intensity at Nz points.

### [B Scan]

The signal processing control portion 140, in response to the A-scan trigger signal supplied from the wavelength-swept laser light source 110, controls the irradiation optical system 132. The irradiation optical system 132 scans the irradiation position of the object beam R3 on the measuring target O. The irradiation optical system 132 moves the irradiation position of the object light R3 in the scanning line direction (also referred to as the “fast axis direction of scanning” and the “X direction”).

The signal processing control portion 140 repeatedly performs the A-scan operation for each irradiation position of the object light R3, and connects the A-scan waveform for each irradiation position of the object light R3. Thus, the signal processing control portion 140 acquires as the tomographic image, a two-dimensional map of the intensity of the backscattered light (the object light), the map having the scanning line direction (the X direction) and the depth direction (the Z direction). Hereinafter, the operation of repeatedly performing the A-scan operation with the movement in the scanning line direction (the fast axis direction of scanning, or the X direction); and connecting the measurement results, is referred to as “B-scan”. Assuming that the illumination positions of the object light R3 for each B-scan are Nx positions, the tomographic image by the B-scan is a two-dimensional luminance data showing the object-light backscatter intensity of Nz×Nx points. FIG. 4(a) shows by an example, one B-scan tomographic image.

### [C Scan]

The irradiation optical system 132 moves the irradiation position of the object light R3 not only in the scanning line direction (the X direction) but also in a direction perpendicular to the scanning line (also referred to as a “slow axis direction of scanning” and a “Y direction”). The signal processing control portion 140 repeatedly performs the B-scan operation and connects the B-scan measurement results. Thus, the signal processing control portion 140 acquires the three-dimensional fault structure data. Hereinafter, the operation of: repeatedly performing the B scan operation with the movement in the direction perpendicular to the scanning line (the Y direction); and connecting the measurement results, is referred to as “C scan”. When the number of implementations of the B-scan for each C-scan is Ny, the fault structure data obtained by the C-scan is a three-dimensional luminance data showing the object-light backscatter intensity of Nz×Nx×Ny points. FIG. 4(b) is a conceptual diagram of a C-scan operation in which the B-scan operation is repeatedly performed with the movement in the direction perpendicular to the scanning line (the Y direction). FIG. 4 (c) shows the skin curved surface Z (X, Y) obtained based on the extraction result of the skin position extracted for every value of the point (X,Y).

### [Effectiveness of OCT Imaging]

Since the fingerprint image of the skin can be obtained in a non-contact manner by OCT imaging, the fingerprint image is not affected by deformation at the time of contact, unlike a case of a skin fingerprint imaging requiring to make the fingertip contact with the glass plate or the like to take a fingerprint image. By OCT imaging, it is possible to obtain the fingerprint image of the dermis. That is, since the fingerprint image can be acquired without being affected by the condition of the skin, the difficulty of reading the skin fingerprint can be eliminated. Further, since the fingertip is not brought into contact with a glass plate or the like, it is hygienic. In addition, it is also suitable for detecting modifications of skin fingerprints.

### [2-3: Image Processing Operation Performed by Image Processing Apparatus 2]

Referring to FIG. 5, a flow of image generation operation performed by the image processing apparatus 2 according to the second example embodiment will be described. FIG. 5 is a flow chart showing the flow of the image processing operation performed by the image processing apparatus 2 according to the second example embodiment. This operation may be performed, for example, when the optical coherence tomography apparatus 100 generates a new three-dimensional luminance data. Further, the three-dimensional luminance data may be acquired in advance from the optical coherence tomography apparatus 100, and the three-dimensional luminance data stored in a storage medium such as the storage apparatus 22 may be loaded to perform the operation.

### [Acquisition Operation Performed by the Acquisition Portion 211]

The acquisition portion 211 acquires the three-dimensional luminance data of the skin (step S20). The acquisition portion 211 may acquire the three-dimensional luminance data indicating the object-light backscatter intensity of Nz×Nx×Ny points generated by the optical coherence tomography apparatus 100.

For example, Nx=300, Ny=300, and Nz=256 may be applied. In this case, the signal processing control portion 140 may: analyze the interfering light spectrum of the object light and reference light; and acquire the luminance data that is decomposed into 256 positions in the Z-direction. The irradiation optical system 132 may scan so as to irradiate 300 with the object light beam, the positions in the fast axis direction (the X direction) of scanning and the 300 positions in the slow axis direction (the Y direction) of scanning. The three-dimensional luminance data can be regarded as a set of Ny (=300) sheets of the B-scan tomographic image of Nx×Nz (=300×256). The acquisition portion 211 may acquire the three-dimensional luminance data indicating the three-dimensional shape as shown in FIG. 4(c).

### [Extraction Operation of the Pattern Image Performed by the First Extraction Portion 212]

The first extraction portion 212 extracts the pattern image of the skin pattern from the three-dimensional luminance data of the skin (step S21). The first extraction portion 212 may extract at least one of a fingerprint image of the skin and a fingerprint image of the dermis. The first extraction portion 212 may extract the pattern image as shown in FIG. 4(d).

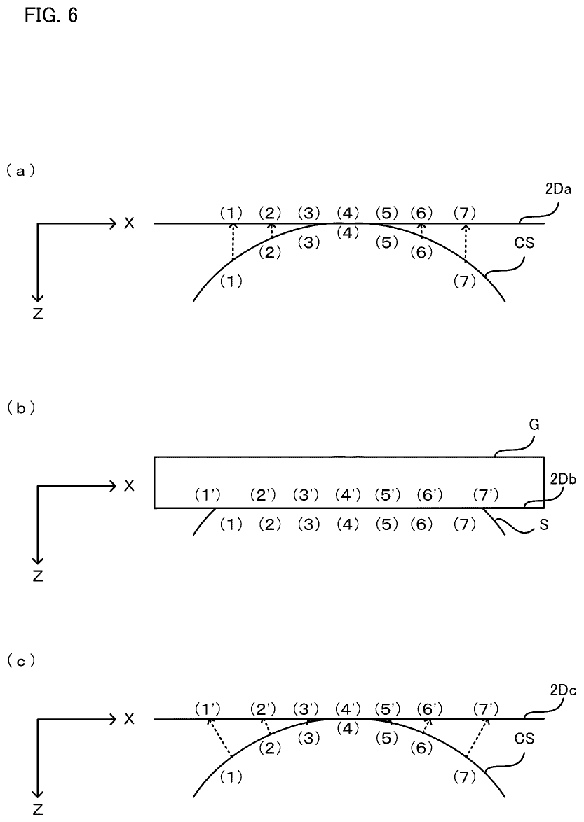

The first extraction portion 212 may extract at least one of the skin fingerprint image and the dermis fingerprint image by orthogonally projecting a curved surface of the finger skin to the tangent plane of the highest-altitude point of the curved surface. FIG. 6(a) is a conceptual diagram of a contactless pattern image 2Da which is obtained when a curved surface CS of the finger skin is projected orthogonally to a tangent plane of the highest-altitude point (4) on the curved surface CS. The contactless pattern image 2Da is a pattern image in which the same position on the XY surface irradiated with the optical beam is reflected on the fingerprint image. Therefore, the distance on the contactless pattern image 2Da differs from the distance on the curved surface of the finger skin. For example, when equidistant points are set on the contactless pattern image 2Da, the distance between the corresponding points on the curved surface of the finger skin is not equidistant, and the distance depends on the normal direction of the curved surface of the finger skin.

For example, as shown in FIG. 6(a), the positions (1) through (7) are equally spaced on the contactless pattern image 2Da. The normal direction of the position (4) is approximately the same as the Z-axis direction. The difference between the Z-axis direction and the normal direction of each of the positions (2) and (6) is larger than the difference between the Z-axis direction and the normal direction of each of the positions (3) and (5), and the difference between the Z-axis direction and the normal direction of each of the positions (1) and (7) is further larger. Then, the interval of the points on the curved surface from the position (4) to the position (3) or from the position (5) to the position (6) is wider than the interval of the points on the curved surface from the position (4) to the position (3) or (5), and the interval of the points on the curved surface from the position (2) to the position (1) or from the position (6) to the position (7) is further wider.

FIG. 6(b) is a conceptual diagram of a fingerprint image taken by contacting a finger S with a glass plate G or the like. As shown in FIG. 6(b), when the finger S is brought into contact with the glass plate G or the like and contact pattern image 2Db is taken, the distance on the contact pattern image 2Db and the distance on the curved surface of the finger skin S are approximately equal to each other.

By the way, the fingerprint image collected in the past, which has been registered in a fingerprint data base, is often obtained by contacting a finger with a glass plate or pressing a finger against a paper, and it is likely to be the contact pattern image 2Db as shown in FIG. 6(b). When the contactless pattern image 2Da is collated with the contact pattern image 2Db, even when both patterns belong to the same person, the features are often different from each other. When the contactless pattern image 2Da is collated with the contact pattern image 2Db, it may happen that, for example, even when both patterns belong to the same person, the collation fails. Then, the collation accuracy may be deteriorated.

It is an important issue to enable high-accuracy collation with fingerprints collected in the past. For example, when collating using fingerprints registered in a database as a black list is carried out in immigration control in Japan, the fingerprints registered in the database were obtained by contacting with a glass plate or pressing on paper. As the fingerprints registered in such databases, it is said that there are about 14000 persons wanted by the International Criminal Police Organization (ICPO) and Japanese police, and about 0.8 million persons who were forcibly abandoned from Japan in the past. There is a demand for a technique to acquire fingerprint images that can match these with high accuracy. Then, in order to cope with this demand, as shown in FIG. 6(c), in the operation of the subsequent steps, the post-move pattern image 2Dc, where the points (1) to (7) have been moved to (1′) to (7′) respectively, is generated.

### [Normal Direction Extraction Operation Performed by the Second Extraction Portion 213]

The second extraction portion 213 extracts the normal direction of the surface of the skin from the three-dimensional luminance data of the skin (step S22). The second extraction portion 213 may analyze the skin shape based on the three-dimensional luminance data. The second extraction portion 213 may extract the normal direction of the curved surface of the skin based on the three-dimensional coordinates of the skin position.

With respect to the angle formed by the normal direction of the curved surface and the Z-axis at a point (nₓ, n_{y}, n_{z}) of a predetermined position n, the angle in the X direction and the angle in the Y direction are calculated respectively.

The angle θₓ in the X direction formed the normal direction of the position n of the curved surface and the Z-axis may be approximated to θₓ=arctan (Δx/Δz) with the difference Δx in the X direction with respect to a vicinity point of the predetermined position n, and with the difference Δz in the Z direction between them. Similarly, the angle θ, in the Y direction formed by the normal direction of the position n of the curved surface and the Z-axis may be approximated to θ_{y}=arctan (Δy/Δz) with the difference Δy in the Y direction with respect to a vicinity point of the predetermined position n, and with the difference Δz in the Z direction between them. The vicinity points of the predetermined position n may include at least one point adjacent to the position n.

### [Generation Operation Performed by the Generation Portion 214]

The generation portion 214 moves the positions of the pixels included in the pattern image on the basis of the normal direction to generate the post-move pattern image 2Dc (step S23). The generation portion 214 may move the positions of the respective pixels of the pattern image based on the normal direction of the position of the pixel included in the pattern image. The generation portion 214 may move the position of the pixel included in the pattern image based on the difference between the normal direction of the central portion of the pattern image and the normal direction of the position of the pixel included in the pattern image. The generation portion 214 may generate the post-move pattern image 2Dc corresponding to the contact pattern image 2Db based on the contactless pattern image 2Da extracted by the first extraction portion 212 and the normal direction extracted by the second extraction portion 213 based on the analysis of the skin shape.

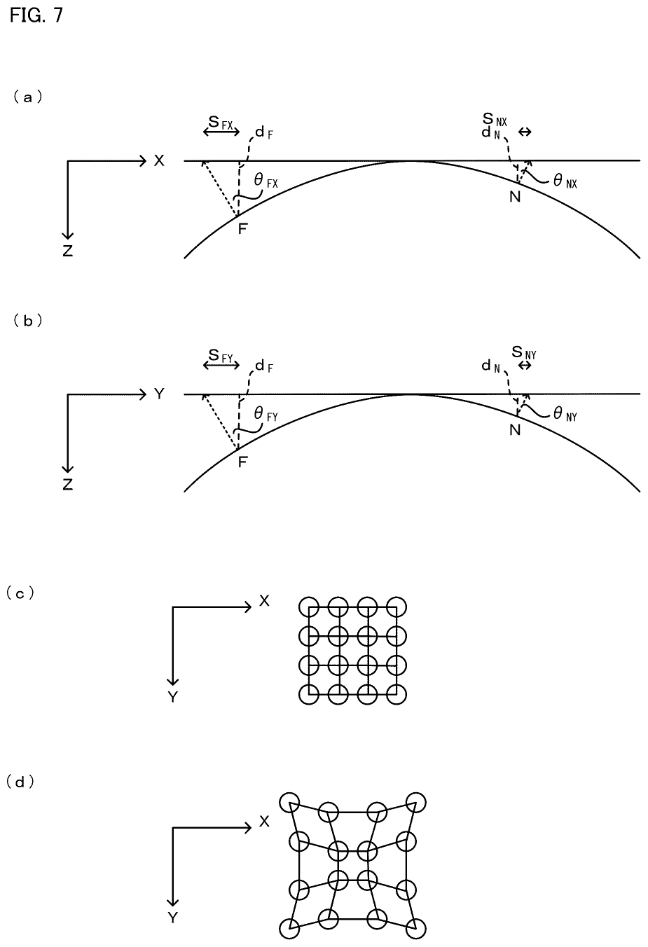

FIG. 7 is a conceptual diagram of the move processing of the pixel. The movement distance s may be calculated using: the difference d in height between the altitude highest point and the position n; and the angle θ in the normal direction at the position n with respect to the Z-axis. The movement distance s, in the X direction may be calculated as sₓ=d×tan θₓ. The movement distance s, in the Y direction may be calculated as s_{y}=d×tan θ_{y}. That is, the pixel (nₓ, n_{y}) of the predetermined position n in the two-dimensional image may be moved to (nₓ+d×tan θₓ, n_{y}+d×tan θ_{y}).

FIG. 7(a) shows by an example, the movement distance sₓ with respect to the X direction. FIG. 7 (b) shows by an example, the movement distance s_{y} with respect to the Y direction. Each of FIGS. 7(a) and (b) shows by an example, a position F that is relatively far away from the altitude highest point and a position N that is relatively close to the altitude highest point. With respect to the relatively far position F, as compared with the relatively close position N, the difference d in height between the altitude highest point and the position n, the angle θ in the normal direction at the position n with respect to the Z-axis, and the movement distance s each becomes large.

FIG. 7(c) is a conceptual diagram of the contactless pattern image 2Da, and FIG. 7(d) is a conceptual diagram of the post-move pattern image 2Dc. As shown in FIGS. 7(c) and (d), as a distance from the center portion of the pattern image 2Dc increases, the movement amount of the position of the pixel included in the pattern image increases.

Further, a table that the angular θ and the movement distance s are correlated with each other may be prepared in, for example, the storage apparatus 22. The generation portion 214 refers to the table to acquire the movement distance corresponding to the angle with respect to each of the X direction and the Y direction, and may move the pixel in the X direction and the Y direction.

### [2-4: Actual Conversion Example]

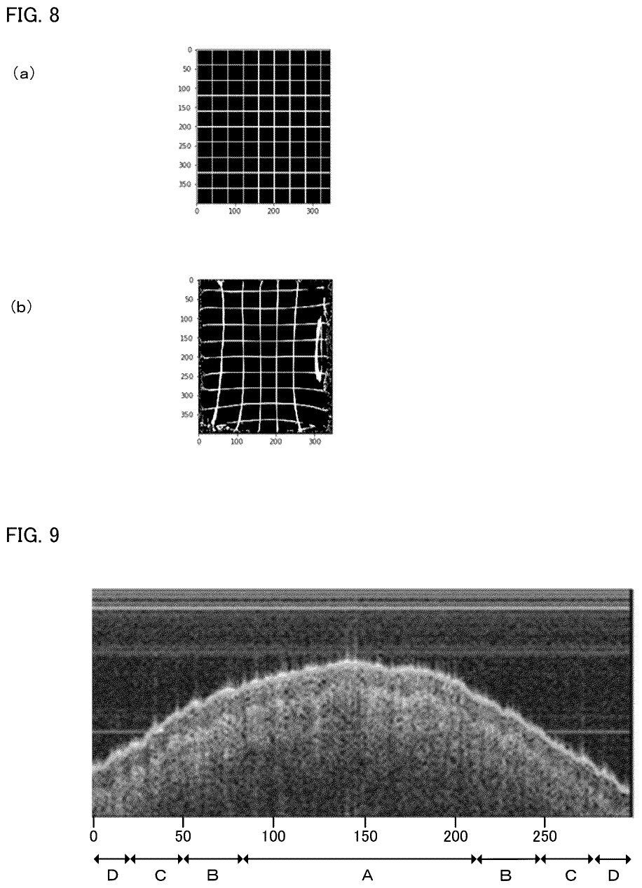

FIG. 8 shows sample images when a lattice image is actually converted by the above-mentioned operation. FIG. 8(a) shows a sample image before the conversion. FIG. 8(b) shows an image example generated by the generation portion 214. In the sample image shown in FIG. 8(b), the distortion of the lattice increases as the distance from the center portion increases.

Further, when the fingerprint image is converted, the interval between the ridges and the width of the ridges gets wider as the distance from the center portion of the image increases.

### [2-5: Technical Effectiveness of Image Processing Apparatus 2]

Since the image processing apparatus 2 according to the second example embodiment moves the position of each pixel of the pattern image, based on the normal direction of the position of the pixel included in the pattern image, each pixel is possible to be moved to an appropriate position. In addition, the pixel is possible to be moved appropriately, because the position of the pixel included in the pattern image is moved based on the difference between: the normal direction of the center portion of the pattern image; and the normal direction of the position of the pixel included in the pattern image.

### 3: Third Example Embodiment

A third example embodiment with respect to the image processing apparatus, image processing method, and recording medium will be described. In the following, using the image processing apparatus 3 to which the third example embodiment of the image processing apparatus, image processing method, and recording medium is applied, the third example embodiment with respect to the image processing apparatus, image processing method, and recording medium will be described.

The image processing apparatus 3 according to the third example embodiment is different in the generation operation by the generation portion 214, as compared with the image processing apparatus 2 according to the second example embodiment. The other features of the image processing apparatus 3 may be identical to those of the image processing apparatus 2.

### [3-1: Generation Operation by the Image Processing Apparatus 3]

The finger surface often has minute irregularities such as ridges, valleys, etc. The three-dimensional shape obtained by OCT imaging often includes fine irregularities and is unlikely to be simple quadratic curves. Therefore, even if the pixel is far from the center portion of the image, the normal direction may be almost the same as the Z-axis. The center portion of the image may be the altitude highest position in the image. The center portion of the image may be the most-raised portion of finger's pad. Further, the normal direction at the image center may be almost the same direction as the Z-axis.

When a finger is actually pressed against a glass plate or the like, the fingerprint position moves at positions far from the center portion of the image. Then, in the third example embodiment, the generation portion 214 increases the movement amount of the pixel included in the pattern image as the distance from the center portion of the pattern image increases.

The generation portion 214 may make a correction so that the movement amount of the pixel is increased, as the distance from the center position where a pixel whose position in the Z-axis is closest to 0 is located.

### [3-2: Technical Effectiveness of the Image Processing Apparatus 3]

Since the correction is made so that the movement amount gets larger as the distance from the center portion in an image gets larger, even when the three-dimensional shape includes fine irregularities, it is possible to generate an appropriate post-move pattern image.

### 4: Fourth Example Embodiment

A fourth example embodiment with respect to the image processing apparatus, image processing method, and recording medium will be described. In the following, using the image processing apparatus 4 to which the fourth example embodiment of the image processing apparatus, image processing method, and recording medium is applied, the fourth example embodiment with respect to the image processing apparatus, image processing method, and recording medium will be described.

The image processing apparatus 4 according to the fourth example embodiment is different in the generation operation by the generation portion 214, as compared with the image processing apparatus 2 according to the second example embodiment and the image processing apparatus 3 according to the third example embodiment. The other features of the image processing apparatus 4 may be identical to those of the image processing apparatus 2 and the image processing apparatus 3

### [4-1: Generation Operation by the Image Processing Apparatus 4]

The generation portion 214 extracts the normal direction of the position of the pixel included in the pattern image, and corrects the extracted normal direction according to the distance from the center portion of the pattern image to the corresponding pixel. With respect to a part out of an angle range predetermined for each position, the generation portion 214 may correct an angle to become continuous with the surrounding angles.

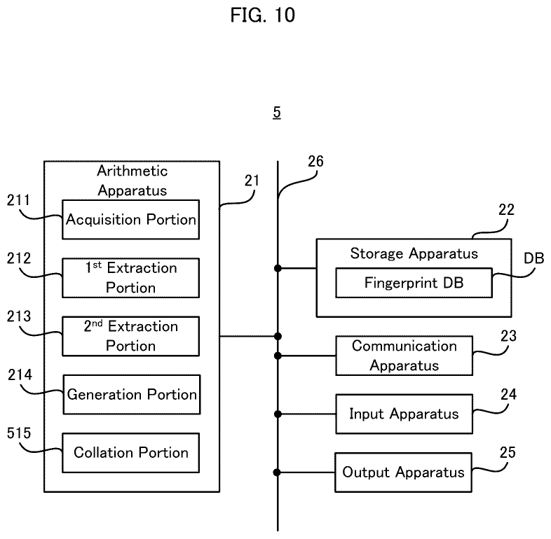

For example, as shown in FIG. 9, in the B-scan tomographic image, the range A, the range B, the range C, and the range D may be set according to the proximity level from the altitude highest point. In the example shown in FIG. 10, the range A is set to a range where X is greater than or equal to 90 and less than 210. The range B is set to a range where X is greater than or equal to 50 and less than 90, and X is greater than or equal to 210 and less than 250. The range C is set to a range where X is greater than or equal to 20 and less than 50, and X is greater than or equal to 250 and less than 280. The range D is set to a range where X is greater than or equal to 0 and less than 20, and X is greater than or equal to 260 and less than 300.

For example, in the range A, the generation portion 214 may correct the normal direction so that the angle of the normal line with respect to the Z-axis is set to less than 5° and 0° or more. Further, in the range B, the generation portion 214 may correct the normal direction so that the angle of the normal line with respect to the Z-axis is set to less than 15° and 5° or more. Further, in the range C, the generation portion 214 may correct the normal direction so that the angle of the normal line with respect to the Z-axis is set to less than 25° and 15° or more. Further, in the range D, the generation portion 214 may correct the normal direction so that the angle of the normal line with respect to the Z-axis is set to less than 35° and 25° or more.

In such cases, when the normal direction at the position where X is 150 (in the range A) is 1°, the angle is within the predetermined angle range (0° or more and less than 5°). Then, the generation portion 214 moves the pixel according to the extracted normal direction. On the other hand, when the normal direction at the position where X is 230 (in the range B) is 1°, the angle is out of the predetermined angle range (less than 15° and 5° or more). Then, the generation portion 214 moves the pixel according to the corrected normal direction. As a correction example, the generation portion 214 may set the corrected normal direction of the position where X is 230 to an average value of the normal directions of positions where X is 220 to 240, that are, vicinity positions of the position where X is 230. Alternatively, the generation portion 214 may set the corrected normal direction of the position where X is 230 to an average value of the normal direction of a position where X is 220 and the normal direction of a position where X is 240, the positions being vicinity of the position where X is 230. The vicinity position includes not only a position which is located within 10-pixel far from the corresponding position, but also a position which is located within 20-pixel far from the corresponding position.

### [4-2: Technical Effectiveness of the Image Processing Apparatus 4]

Since the extracted normal direction is corrected according to the distance from the center portion of the pattern image to the corresponding pixel. Thereby, it is possible to generate an appropriate post-move pattern image even when the three-dimensional shape includes fine irregularities.

### 5: Fifth Example Embodiment

A fifth example embodiment with respect to the image processing apparatus, image processing method, and recording medium will be described. In the following, using the image processing apparatus 5 to which the fifth example embodiment of the image processing apparatus, image processing method, and recording medium is applied, the fifth example embodiment with respect to the image processing apparatus, image processing method, and recording medium will be described.

### [5-1: Configuration of the Image Processing Apparatus 5]

Referring to FIG. 10, the configuration of the image processing apparatus 5 according to the fifth example embodiment will be described. FIG. 10 is a block diagram illustrating a configuration of the image processing apparatus 5 according to the fifth example embodiment.

As shown in FIG. 10, the image processing apparatus 5 according to the fifth example embodiment differs from the image processing apparatuses 2 to 4 in the second to fourth example embodiments, in that the arithmetic apparatus 21 includes a collation portion 515 and the storage apparatus 22 stores a fingerprint database DB in which registered pattern images are registered.

However, the storage apparatus 22 may not store the fingerprint database DB. The other features of the image processing apparatus 5 may be identical to the other features of the image processing apparatuses 2 to 4.

The image processing apparatus 5 may: generate using the three-dimensional luminance data, a fingerprint image suitable for fingerprint authentication; register the fingerprint image in the fingerprint database DB in advance; and perform biometric authentication processing by collating the fingerprint image.

The collation portion 515 collates the post-move pattern image 2Dc with the registered pattern image registered in advance. The collation portion 515 may collate the post-move pattern image 2Dc generated by the generation portion 214 with the fingerprint image registered in the registered pattern image. It is possible to provide collation with high accuracy between: a fingerprint image obtained by contactless measurement by OCT imaging and extraction; and a fingerprint image which was taken in a contact manner in the part to be recorded in a database.

For example, a high score may not be obtained by collating the contactless pattern image 2Da shown in FIG. 6 (a) with the contact pattern image 2Db shown in FIG. 6 (b). However, a high score can be obtained by collating the post-move pattern image 2Dc shown in FIG. 6 (c) with the contact pattern image 2Db shown in FIG. 6 (b).

### [5-2: Technical Effectiveness of the Image Processing Apparatus 4]

Since the contactless pattern image 2Da is converted into the post-move pattern image 2Dc, even when it is collated with the contact pattern image 2Db, collation with high accuracy can be provided.

### 6: Learning of Generate Post-Move Pattern Image

In addition, a generation engine which generates the post-move pattern image by a machine learning with a machine mechanism. The generation portion 214 may generate the post-move pattern image by using the generation engine.

For example, the generated post-move pattern image is collated with the registered pattern image registered in advance. When these are coincident, position information of each coincident feature point is acquired. The learning data may be set to data where: the position of the coincident feature point; a difference (distances in the X direction and the Y direction) between the coincident feature point in the registered pattern image and the coincident feature point in the pattern image; and the normal direction of the pattern image with respect to the coincident feature point are correlated with each other. The difference corresponds to the movement amount. The generation engine may be generated by executing the machine learning using the learning data.

The learning mechanism may make the generation engine learn a method of generating the post-move pattern image, based on the collation result between the contact pattern image and the post-move pattern image generated by the generation portion 214.

When the position of the pixel of the pattern image and the normal direction of the pixel are inputted, the generation engine may output the movement amount of the pixel.

The learning data may be data including information of a distance from the fingerprint center in addition to the position, the difference, and the normal direction.

### 7: Labeling of Fingerprint Image

As the fingerprint image, there are at least three types thereof: (1) the contactless pattern image 2Da acquired by simply projecting to a flat surface, a three-dimensional shape obtained by OCT imaging, or the like; (2) the contact pattern image 2Db acquired by pushing a finger on a glass plate; (3) the post-move pattern image 2Dc acquired by processing in the same manner as in (2), a three-dimensional shape obtained by OCT imaging or the like. Then, depending on each acquisition manner, the fingerprint image may be labeled and registered in the fingerprint database. When the fingerprint image registered in the fingerprint database is used for authentication, the label may be used for reference for executing the authentication according to the acquisition manner.

In each of the example embodiments mentioned above, as living body information of a target of the optical coherence tomography, a pattern of finger skin (fingerprint) is exemplified. However, the living body information is not limited to the fingerprint. As the living body information, the iris, palmprint, or footprint, other than the fingerprint, may be adopted, and the optical coherence tomography of these living body information may be applied. Since the iris is comprised of muscle fibers, the feature amount of the iris can be acquired from the optical coherence tomography image, and the iris authentication using the feature amount can be executed. The fingerprint may be a finger pattern of a hand or may be a finger pattern of a foot. When an image of a pattern including a fingerprint of a hand or foot is taken with the optical coherence tomography, light passing through plastic and the like may be used.

### 8: Supplementary Note

With respect to the example embodiments described above, the following supplementary notes will be further disclosed.

### [Supplementary Note 1]

An image processing apparatus comprising: an acquisition unit that is configured to acquire a three-dimensional luminance data of skin, the data being generated by optical coherence tomography performed by irradiating the skin of a finger with an optical beam in a two-dimensionally scanning manner; a first extraction unit that is configured to extract from the three-dimensional luminance data of the skin, a pattern image of a pattern of the skin;
a second extraction unit that is configured to extract from the three-dimensional luminance data of the skin, a normal direction of a surface of the skin; and a generation unit that is configured to move a position of a pixel included in the pattern image based on the normal direction to generate a post-move pattern image.

### [Supplementary Note 2]

The image processing apparatus according to the supplementary note 1, wherein the generation unit is configured to move the position of each pixel of the pattern image, based on the normal direction of the position of the pixel included in the pattern image.

### [Supplementary Note 3]

The image processing apparatus according to the supplementary note 1 or 2, wherein the generation unit is configured to move the position of the pixel included in the pattern image, based on a difference between: the normal direction of a center portion of the pattern image; and the normal direction of the position of the pixel included in the pattern image.

### [Supplementary Note 4]

The image processing apparatus according to any one of the supplementary notes 1 to 3, wherein the generation unit is configured to increase a movement amount of the position of the pixel included in the pattern image, as a distance from a center portion of the pattern image increases.

### [Supplementary Note 5]

The image processing apparatus according to any one of the supplementary notes 1 to 4, wherein the second extraction unit is configured to extract the normal direction of the position of the pixel included in the pattern image, and to correct according to a distance from a center portion of the pattern image to a corresponding pixel, the normal direction extracted.

### [Supplementary Note 6]

The image processing apparatus according to any one of the supplementary notes 1 to 5, further comprising a collation unit that is configured to collate the post-move pattern image with a registered pattern image registered in advance.

### [Supplementary Note 7]

An image processing method comprising: acquiring a three-dimensional luminance data of skin, the data being generated by optical coherence tomography performed by irradiating the skin of a finger with an optical beam in a two-dimensionally scanning manner; extracting from the three-dimensional luminance data of the skin, a pattern image of a pattern of the skin; extracting from the three-dimensional luminance data of the skin, a normal direction of a surface of the skin; and moving a position of a pixel included in the pattern image based on the normal direction to generate a post-move pattern image.

### [Supplementary Note 8]

A recording medium storing a computer program that makes a computer execute an image processing method, the image processing method comprising: acquiring a three-dimensional luminance data of skin, the data being generated by optical coherence tomography performed by irradiating the skin of a finger with an optical beam in a two-dimensionally scanning manner; extracting from the three-dimensional luminance data of the skin, a pattern image of a pattern of the skin; extracting from the three-dimensional luminance data of the skin, a normal direction of a surface of the skin; and moving a position of a pixel included in the pattern image based on the normal direction to generate a post-move pattern image.

At least a part of the constituent components of the above-described example embodiments can be appropriately combined with at least the other part of the constituent components of the above-described example embodiments. A part among the constituent components of the above-described example embodiments may not be used. Also, to the extent permitted by law, the disclosure of all references cited in the above-mentioned disclosure (e.g., the Patent Literature) is incorporated as a part of the description of this disclosure.

This disclosure may be appropriately modified in a range which is not contrary to the technical idea which can be read throughout the claims and whole specification. The image processing apparatus, image processing method, and recording medium with such modifications are also included in the technical idea of this disclosure.

### DESCRIPTION OF REFERENCE SIGNS

1,2,3,4,5 Image processing apparatus
11,211 Acquisition portion
12,212 First extraction portion
13,213 Second extractor portion
14,214 Generation portion
515 Collation portion
100 Optical coherence tomography apparatus
110 Wavelength-swept laser light source
120 Optical-interference light receiving portion
130 Optical beam scanning portion
140 Signal processing control portion
O Measuring target
121 Circulator
122 Branching and merging portion
123 Reference light mirror
124 Balance type photoreceiver
131 Fiber collimator
132 Irradiation optical system
R1 Object light
R2 Reference light
R3 Object light
R4 Reference light
R5 interference light
R6 interference light What is claimed is:

1. An image processing apparatus comprising:
at least one memory configured to store instructions; and
at least one processor configured to execute the instructions to:
acquire a three-dimensional luminance data of skin, the data being generated by optical coherence tomography performed by irradiating the skin of a finger with an optical beam in a two-dimensionally scanning manner;
extract from the three-dimensional luminance data of the skin, a pattern image of a pattern of the skin;
extract from the three-dimensional luminance data of the skin, a normal direction of a surface of the skin; and
move a position of a pixel included in the pattern image based on the normal direction to generate a post-move pattern image.

2. The image processing apparatus according to claim 1, wherein
the at least one processor is further configured to execute the instructions to
move the position of each pixel of the pattern image, based on the normal direction of the position of the pixel included in the pattern image.

3. The image processing apparatus according to claim 1, wherein
the at least one processor is further configured to execute the instructions to
move the position of the pixel included in the pattern image, based on a difference between: the normal direction of a center portion of the pattern image; and the normal direction of the position of the pixel included in the pattern image.

4. The image processing apparatus according to claim 1, wherein
the at least one processor is further configured to execute the instructions to
increase a movement amount of the position of the pixel included in the pattern image, as a distance from a center portion of the pattern image increases.

5. The image processing apparatus according to claim 1, wherein
the at least one processor is further configured to execute the instructions to
extract the normal direction of the position of the pixel included in the pattern image, and correct according to a distance from a center portion of the pattern image to a corresponding pixel, the normal direction extracted.

6. The image processing apparatus according to claim 1, wherein
the at least one processor is further configured to execute the instructions to
collate the post-move pattern image with a registered pattern image registered in advance.

7. An image processing method comprising:
acquiring a three-dimensional luminance data of skin, the data being generated by optical coherence tomography performed by irradiating the skin of a finger with an optical beam in a two-dimensionally scanning manner;
extracting from the three-dimensional luminance data of the skin, a pattern image of a pattern of the skin;
extracting from the three-dimensional luminance data of the skin, a normal direction of a surface of the skin; and
moving a position of a pixel included in the pattern image based on the normal direction to generate a post-move pattern image.

8. A non-transitory recording medium storing a computer program that makes a computer execute an image processing method, the image processing method comprising:
acquiring a three-dimensional luminance data of skin, the data being generated by optical coherence tomography performed by irradiating the skin of a finger with an optical beam in a two-dimensionally scanning manner;
extracting from the three-dimensional luminance data of the skin, a pattern image of a pattern of the skin;
extracting from the three-dimensional luminance data of the skin, a normal direction of a surface of the skin; and
moving a position of a pixel included in the pattern image based on the normal direction to generate a post-move pattern image.
